(19) United States
(12) Patent Application Publication
(10) Pub. No.: US 2019/0339905 A1
(43) Pub. Date: Nov. 7, 2019

(54) STORAGE APPARATUS AND INFORMATION PROCESSING METHOD

(71) Applicant: HITACHI, LTD., Tokyo (JP)

(72) Inventors: Makio MIZUNO, Tokyo (JP); Masanori TAKADA, Tokyo (JP); Sadahiro SUGIMOTO, Tokyo (JP)

(21) Appl. No.: 16/074,129

(22) PCT Filed: Mar. 17, 2016
(86) PCT No.: PCT/JP2016/058565

§ 371 Date: Jul. 31, 2018

(51) Int. Cl. G06F 3/06

(52) U.S. Cl. CPC G06F 3/0659; G06F 3/0611; G06F 3/0673

(57) ABSTRACT

There is provided a storage apparatus and an information processing method which can improve processing performance. In the storage apparatus, the controller generates a queue group including a plurality of command queues in which different priorities are set, in the controller itself or in the storage device, and posts the command requiring a faster processing among commands for the storage device in the command queue with a higher priority, and the storage device sequentially and repeatedly performs rounds in which the command is fetched from the command queue with a corresponding priority to be processed, for each priority and at this time, the storage device fetches and processes more commands in the round with a higher priority.

### TECHNICAL FIELD

The present invention relates to a storage apparatus and an information processing method, and, for example, it is preferable that the present invention is applied to a storage apparatus in which a solid state drive (SSD) is mounted as a storage device.

### BACKGROUND ART

Recently, multicore processors have been manufactured according to advance in miniaturization technology. Meanwhile, in a general protocol processing processor, a channel control function is provided by only one or a few processors. Accordingly, in a storage apparatus including a large number of processors or processor cores, the above-described channel control function is used exclusively between the processors or the processor cores, and processing time for an input-output (IO) command from a host computer increases.

Technologies described in PTLs 1 and 2 are conventionally known as techniques for suppressing such an increase in processing time.

PTL 1 describes a disk array control apparatus that improves I/O performance of the disk array control apparatus. Specifically, the disk array control apparatus includes at least one interface unit with a host computer, at least one interface unit with a plurality of magnetic disk apparatuses, and at least one physically independent shared memory unit that stores data of the magnetic disk apparatus and control information on the disk array control apparatus, and can access the shared memory unit from an interface unit with the host computer or an interface unit with a plurality of magnetic disk apparatuses via a selector, and an interface unit of the host computer or interface units of a plurality of magnetic disk apparatuses and a selector, and the selector and the shared memory unit are connected by an access path.

In addition, the selector of the disk array control apparatus includes means for mutually connecting a plurality of input ports from an interface unit of the host computer or interface units of a plurality of magnetic disk apparatuses to a plurality of output ports to the shared memory unit, means for storing connection requests from the plurality of input ports to the output ports in order of arrival of the connection requests, and arbitration means for performing arbitration between a plurality of connection requests and allocating the connection requests from the input ports to the respective output ports.

Furthermore, the arbitration means has a configuration in which an output port is allocated to a request if a first request of the connection requests stored in the order of arrival is the request to the currently vacant output port, a second request is examined if the first request of the connection requests stored in the order of arrival is a request to the currently used output port, the output port is allocated to a request if a second connection request is the request to the currently vacant output port, a third request is examined if the second connection request is a request to the currently used output port, and thereafter, arbitration (assignment) of the connection request to the output port is repeated as many times as the number of output ports that are currently vacant at most.

In addition, PTL 2 discloses a storage system, a storage apparatus, a priority control apparatus, and a priority control method for solving an internal delay caused by expansion, solving imbalance of command execution time, and stabilizing apparatus performance, in a scalable storage including a plurality of nodes. Specifically, the storage system is configured with a host PC and a storage apparatus including a plurality of nodes, and the storage apparatus preferentially processes a command passing through the node among commands from the host PC. Alternatively, the storage apparatus preferentially processes a command with a short transmission length among the commands from the host PC.

However, the data transfer is frequently performed in the storage apparatus in accordance with IO commands or the like from the host computer, but the data transfer is classified into two types of data transfer directly influencing apparatus performance and data transfer not directly influencing the apparatus performance.

In addition, recently, a low price of a flash memory, an advanced use, and mounting an SSD in which the flash memory is mounted on a drive on a storage system has been promoted. Along with spread of the SSD, non-volatile memory Express (NVM Express) has recently been formulated as a new communication protocol for the purpose of solving the above-mentioned increase in processing time (see NPL 1). One of features of the NVM Express is that a plurality of queues which process commands, that is 65536 queues can be provided as a channel control function.

### CITATION LIST

### Patent Literature

PTL 1: JP-A-2000-10901

PTL 2: JP-A-2009-193260

### Non-Patent Literature

NPL 1: NVM express Specification Revision 1.2, issued in 2014, author NVM Express, Inc., page 120

### SUMMARY OF INVENTION

### Technical Problem

According to a mechanism that improves IO performance of a disk array control apparatus disclosed in PTL 1, a vacant port is uniformly allocated irrespective of influence on the apparatus performance. That is, there is a problem in which a request that does not directly influence the apparatus performance is also allocated if the request is a request to a vacant port, a request directly influencing the apparatus performance is waited for during the time, and thereby processing time is increased.

In addition, in the scalable storage disclosed in PTL 2, “a command with a short transmission length among commands from a host is preferentially processed” can be regarded as a request requiring response time, from a viewpoint at a command requiring response time and a command not requiring the response time. However, in a case where there are a command requiring the response time and a command not requiring the response time even among the commands with a short transmission length, priority is given to the command not requiring the response time. As a result, there is a problem in which processing of the command requiring response time is waited for, and thereby, the processing time increases.

The present invention is made in view of the above point, and is to propose a storage apparatus and an information processing method which can improve processing performance.

### Solution to Problem

In the present invention for solving the problem, a storage apparatus that provides a storage area for reading and writing data from and to a host computer, includes a storage device that provides the storage area; and a controller that controls reading and writing of data from and to the storage device, in which the controller generates a queue group including a plurality of command queues in which different priorities are set, in the controller itself or in the storage device, and posts the command requiring a faster processing among commands for the storage device in the command queue with a higher priority, and in which the storage device sequentially and repeatedly performs rounds in which the command is fetched from the command queue with a corresponding priority to be processed, for each priority and fetches and processes more commands in the round with a higher priority.

In addition, in the present invention, an information processing method that is performed in a storage apparatus which provides a storage area for reading and writing data from and to a host computer and which includes a storage device that provides the storage area and a controller that controls reading and writing of data from and to the storage device, includes a first step causing the controller to generate a queue group including a plurality of command queues in which different priorities are set, in the controller itself or in the storage device; a second step causing the controller to post the command requiring a faster processing among commands for the storage device in the command queue with a higher priority; and a third step causing the storage device to sequentially and repeatedly perform rounds in which the command is fetched from the command queue with a corresponding priority to be processed, for each priority, in which, in the third step, the storage device fetches and processes more commands in the round with a higher priority.

### Advantageous Effects of Invention

According to the present invention, it is possible to realize a storage apparatus and an information processing method that can more quickly process a command requiring faster processing, and thus, can improve processing performance.

### BRIEF DESCRIPTION OF DRAWINGS

FIG. 1 is a block diagram illustrating a configuration of a computer system according to the present embodiment.

FIG. 2 is a block diagram illustrating a configuration of a storage device according to the present embodiment.

FIG. 3 is a flowchart provided for explanation of I/O processing performed by a storage apparatus.

FIG. 4 is a sequence diagram illustrating a flow of write processing in the storage apparatus.

FIG. 5 is a sequence diagram illustrating a flow of read processing in the storage apparatus.

FIG. 6 is a conceptual diagram provided for outline explanation of the present invention.

FIG. 7 is a flowchart illustrating a processing sequence of queue generation processing.

FIG. 8 is a conceptual diagram illustrating a configuration of a queue management table.

FIG. 9 is a conceptual diagram illustrating a configuration of a maximum command number management table.

FIG. 10 is a flowchart illustrating a processing sequence of arbitration processing.

FIG. 11 is a flowchart illustrating a processing sequence of command queue selection processing.

FIG. 12 is a flowchart illustrating a processing sequence of fetch command number determination processing.

FIG. 13 is a conceptual diagram illustrating a configuration of a processing command number management table.

FIG. 14 is a conceptual diagram illustrating a flow of fetch command number determination in the processing command number management table.

FIG. 15 is a schematic diagram schematically illustrating a configuration of a management screen.

FIG. 16 is a conceptual diagram illustrating a state of a queue management table according to a second embodiment.

FIG. 17 is a block diagram illustrating a configuration of a storage device according to the second embodiment.

### DESCRIPTION OF EMBODIMENTS

Hereinafter, embodiments of the present invention will be described with reference to the drawings.

In the following description, various types of information may be described by expression such as a “management table”, but the various types of information may be expressed by a data structure other than the table. In addition, in order to represent that the information does not depend on the data structure, the “management table” can be called “management information”.

In addition, there is a case where processing is described by using a “program” as a subject. Since the program is executed by a processor, for example, a central processing unit (CPU), predetermined processing is performed. In order to make execution while appropriately using a storage resource (for example, a memory) and a communication interface apparatus (for example, a communication port), a subject of processing may be a processor. The processor may have dedicated hardware in addition to the CPU. The computer program may be installed in each computer from a program source. The program source may be provided by, for example, a program distribution server, a storage medium or the like.

In addition, each element can be identified by a number or the like, but other types of identification information such as a name may be used as long as the information is identifiable. The same reference numerals or symbols are attached to the same units in the figures and the description of the present invention, but the present invention is not constrained to the present embodiment, and any application example matching the idea of the present invention is included in the technical scope of the present invention. In addition, unless being constrained, in particular, each configuration element may be plural or singular.

### (1) First Embodiment

In the present embodiment, a method of improving processing speed by using a queue with priority in a computer system as compared with a method of the related art will be described. Hereinafter, the present embodiment will be described in detail with reference to the drawings. Since details of an NVM Express standard are described in Non-Patent literature 1, detailed description thereof will be omitted, and only the items necessary for the description on the present embodiment will be appropriately described.

### (1-1) Configuration of Computer System According to the Present Embodiment

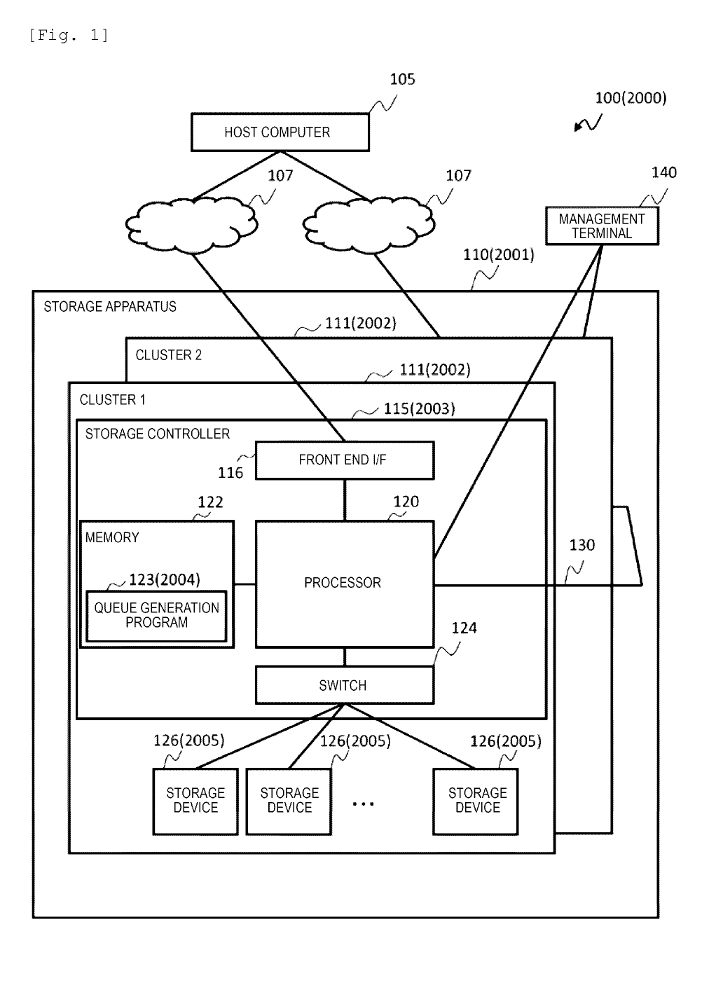

FIG. 1 illustrates a configuration of a computer system 100 according to the present embodiment. The computer system 100 is configured to include a host computer 105 that performs data processing and arithmetic processing, and a storage apparatus 110. The host computer 105 and the storage apparatus 110 are connected to each other via a network 107 such as a storage area network (SAN).

The host computer 105 is a computer apparatus including an information processing resource such as a CPU and a memory, and is configured with, for example, an open system server, a mainframe computer or the like. The host computer 105 transmits a write command or a read command to the storage apparatus 110 via the network 107.

The storage apparatus includes a cluster 111 including one or a plurality of storage devices 126 and a storage controller 115 which controls input and output of data to and from the storage device 126. In a case of the storage apparatus 110 according to the present embodiment, two clusters 111 are provided so as to put emphasis on availability and continuously provide a service. The two clusters 111 have the same configuration and function. One cluster 111 may be connected to the storage device 126 of the other cluster 111 via a switch 124 which will be described below. In addition, the storage device 126 of one cluster 111 may be connected from the other cluster 111 via the switch 124.

In each cluster 111, the storage device 126 is an apparatus that stores data of the host computer 105. The storage device 126 may be an SSD in which a nonvolatile memory such as a flash memory is mounted, an optical disk, a magneto-optical disk, or the like. In addition to this, various media such as a magnetoresistive random access memory (MRAM), a phase-change memory, a resistive random-access memory (ReRAM), and a ferroelectric random access memory (FeRAM) can be used. A multi-stage connection configuration in which a plurality of switches 124 are connected and the storage device 126 is further connected may be applied.

The storage controller 115 is configured to include a front end interface 116, a processor 120, a memory 122, a switch 124, and an inter-storage controller path 130.

The front end interface 116 includes an interface connected to the host computer 105, and performs predetermined protocol processing for a packet received from the host computer 105 and a packet to be transmitted to the host computer 105.

For example, the front end interface 116 acquires information on a storage location of read data or write data in the storage device 126 included in the packet received from the host computer 105, a capacity of the packet, or the like, specifies a command contained in the packet, or converts the received packet into a form that is used inside the storage controller 115.

In addition, the front end interface 116 generates a packet that can be transmitted to the host computer 105 by adding identification data of the host computer 105 which is a transmission destination, control data relating to a command to the host computer 105, or the like to the read data, based on a communication protocol between the storage controller 115 and the host computer 105, for a packet to be transmitted to the host computer 105.

The processor 120 controls each configuration element in the storage controller 115, such as the front end interface 116. For example, the processor 120 sets a data transfer parameter of the front end interface 116. In addition, the processor 120 monitors a failure of the storage apparatus 110, and performs processing corresponding to a failure when the failure is detected.

The inter-storage controller path 130 is a communication interface between a plurality (two in FIG. 1) of storage controllers 115. The inter-storage controller path 130 is, for example, a non transparent bridge (NTB). Alternatively, the inter-storage controller path 130 may be an Infiniband or the Ethernet (registered trademark) using an interface card (not illustrated), or may be an interface which can perform data communication between the processors 120 or between the memories 122.

Recently, a fiber channel (FC), a fiber channel over Ethernet (FCoE) (registered trademark) which transfers a fiber channel packet on the Ethernet (registered trademark) in recent years, or the like can be applied as a protocol used between the host computer 105 and the storage controller 115. For example, the storage controller 115 is configured by a plurality of boards on which components are mounted respectively, and furthermore, each board often includes a plurality of components mounted thereon. Accordingly, it may be better to use a protocol, which is used in the storage controller 115, suitable for communication between the plurality of boards or between the components on a board, and for example, PCI-Express (registered trademark), Rapid-IO (registered trademark) and the like which are a bus standard of a computer are used.

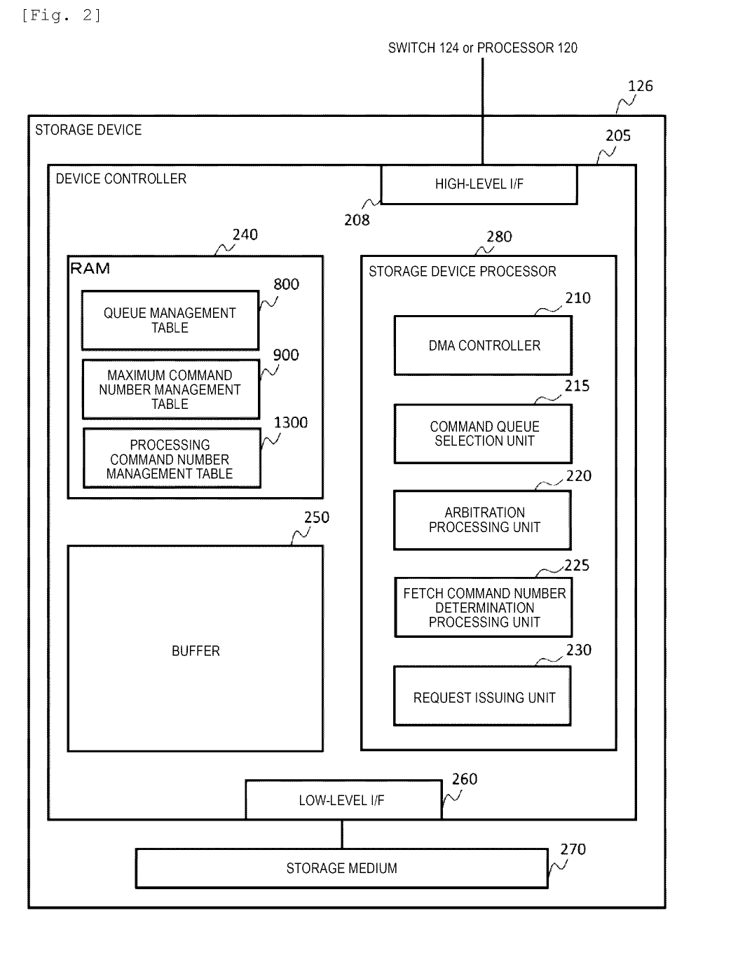

FIG. 2 illustrates a configuration of the storage device 126 according to the present embodiment. As illustrated in FIG. 2, the storage device 126 is configured with a device controller 205 and a storage medium 270.

The device controller 205 includes a upper interface 208, a random access memory (RAM) 240, a buffer 250 and a lower interface 260, a direct memory access (DMA) controller 210, a command queue selection unit 215, an arbitration processing unit 220, a fetch command number determination processing unit 225, and a request issuing unit 230.

The upper interface 208 is connected to the switch 124 of the storage controller 115 (FIG. 1) and the respective configuration element in the device controller 205. However, the upper interface 208 may be directly connected to the processor 120 (FIG. 1). The upper interface 208 receives a read command or write command from the processor 120, a logical block address (LBA) indicating a logical storage location of a read destination or a write destination, write data at the time of the write command, or the like.

The RAM 240 is configured with, for example, a volatile memory such as a dynamic random access memory (DRAM). A program (not illustrated) and management information (not illustrated) for controlling the device controller 205, a queue management table 800, a maximum command number management table 900, a processing command number management table 1300, which will be described below, and the like are stored in the RAM 240.

The buffer 250 is a data storage area which temporarily retains data to be written to and read from the storage medium 270, in the device controller 205. The RAM 240 may be configured to include a part or all of the buffer 250.

The lower interface 260 is hardware that functions as an interface for the storage medium 270. The lower interface 260 is generally connected to a plurality of storage media 270 via a plurality of buses (not illustrated).

The storage device processor 280 is a processor that controls an overall operation of the storage device 126, and includes, for example, a direct memory access (DMA) controller 210, a command queue selection unit 215, an arbitration processing unit 220, a fetch command number determination processing unit 225, and a request issuing unit 230, as hardware.

The DMA controller 210 has a function of reading and writing data between the memory 122 and the buffer 250, such as, reading the data stored in the memory 122 (FIG. 1) of the storage controller 115 (FIG. 1) into the buffer 250 in the storage device 126 itself, or writing the data stored in the buffer 250 into the memory 122, using the transfer parameter (not illustrated) stored in the RAM 240. In addition, the request issuing unit 230 has a function of reading and writing data between the buffer 250 and the storage medium 270, such as, storing the data stored in the buffer 250 in the corresponding storage medium 270, or reading the data stored in the storage medium 270 into the buffer 250. Functions of the command queue selection unit 215, the arbitration processing unit 220, and the fetch command number determination processing unit 225 will be described below.

The DMA controller 210, the command queue selection unit 215, the arbitration processing unit 220, the fetch command number determination processing unit 225, and the request issuing unit 230 may be configured as software which is embodied as the storage device processor 280 executes a corresponding program (not illustrated) stored in the RAM 240.

The storage medium 270 is a storage element that stores and retains data from the host computer 105, and is configured by, for example, a NAND type flash memory and the like. In addition to the flash memory, various media such as an MRAM, a phase change memory, an ReRAM, an FeRAM, and the like can be used as the storage medium 270.

The storage medium 270 operates according to a request given from the storage device processor 280 via the lower interface 260, receives a command, a request target block, and page information which are given via the lower interface 260 at the time of writing, and writes write data which is transferred via the lower interface 260 to a designated page. In addition, the storage medium 270 receives a command, a request target block, and page information which are given from the storage device processor 280 via the lower interface 260, reads data of the designated page, and transfers the read data to the lower interface 260.

A plurality of storage media 270 may be provided in the storage device 126, and the plurality of storage media 270 may configure a redundant arrays of inexpensive disks (RAID) group to redundantly manage data. Thereby, even in a case where a failure occurs in a part of the storage medium 270 configuring the RAID group, the data stored in the storage medium 270 can be recovered based on data or a parity of another or the plurality of storage media 270 belonging to the same RAID group.

### (1-2) Type of Host IO Processing

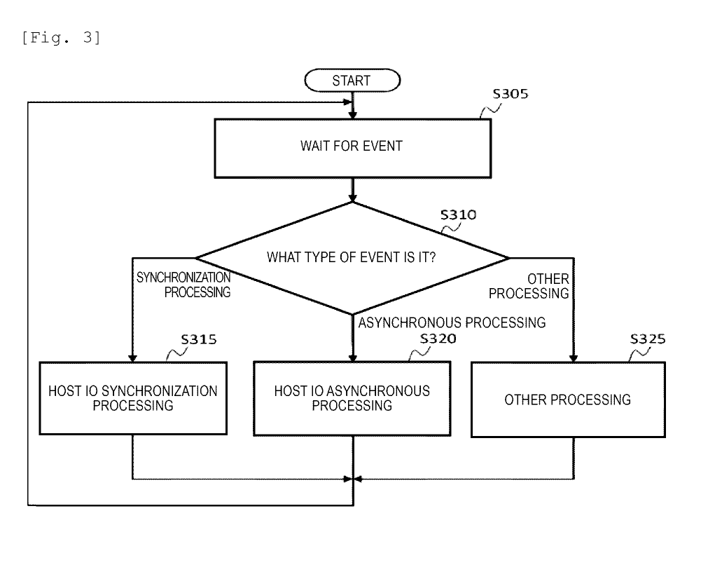

FIG. 3 illustrates a flow of IO processing performed by the storage apparatus 110. In normal time, the storage apparatus 110 awaits occurrence of an event (S305), and in a case where any event occurs, the storage apparatus 110 determines a type of the event (S310).

The storage apparatus 110 performs host IO synchronization processing (S315) in a case where the event is the host IO synchronization processing, performs host IO asynchronous processing (S320) if the event is the host IO asynchronous processing, and performs the processing (S325) if the event is neither the host IO synchronization processing nor the host IO asynchronous processing. Thereafter, the storage apparatus 110 returns to step S305.

Here, the host IO synchronization processing is IO processing that is performed in synchronization with an IO command from the host computer 105. Accordingly, the host IO synchronization processing is processing having great influence on a response performance of the storage apparatus 110 as viewed from the host computer 105. There is read processing, write processing, or the like as an example of the host IO synchronization processing.

The host IO asynchronous processing is IO processing that is performed asynchronously with an IO command from the host computer 105. The host IO asynchronous processing can be classified into two types of unconstrained host IO asynchronous processing and constrained host IO asynchronous processing, depending on whether or not to have influence on the response performance of the storage apparatus 110 as viewed from the host computer 105.

The unconstrained host IO asynchronous processing is processing that has no influence on the response performance of the storage apparatus 110 as viewed from the host computer 105. There is data read ahead processing in a sequential read as an example of the unconstrained host IO asynchronous processing.

Meanwhile, the constrained host IO asynchronous processing is processing that has indirect influence on the response performance of the storage apparatus 110 as viewed from the host computer 105. There is destaging processing or the like of storing data stored in a cache memory area of the memory 122 in the storage device 126 in a state where a remaining capacity of the memory 122 is not sufficient, as an example of constrained host IO asynchronous processing.

The constrained host IO asynchronous processing may be performed at any timing since there is no direct relationship with the IO command from the host computer 105. However, for example, since the constrained asynchronous processing is processing that has indirect influence on the response performance of the storage apparatus 110, it is better to perform processing earlier. That is, it is necessary to end such processing within a certain time.

The storage apparatus 110 provides many functions for business continuity and storage management. For example, a replication function for providing the business continuity and a virtualization function as the storage management are provided. Processing necessary for providing the functions is also performed in the storage controller 115. The necessary processing can be classified as any one of the host IO synchronization processing, the unconstrained host IO asynchronous processing, and the constrained host IO asynchronous processing. For example, the replication processing performed asynchronously with the host IO processing among the replication functions can be classified as the unconstrained host IO asynchronous processing.

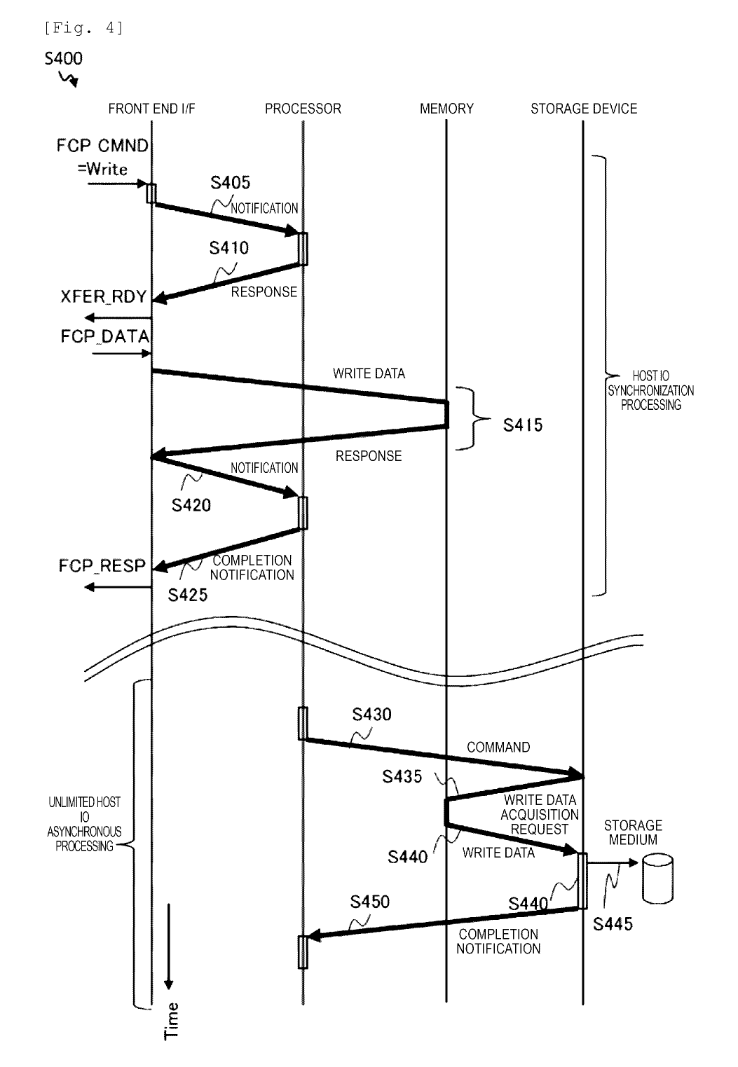

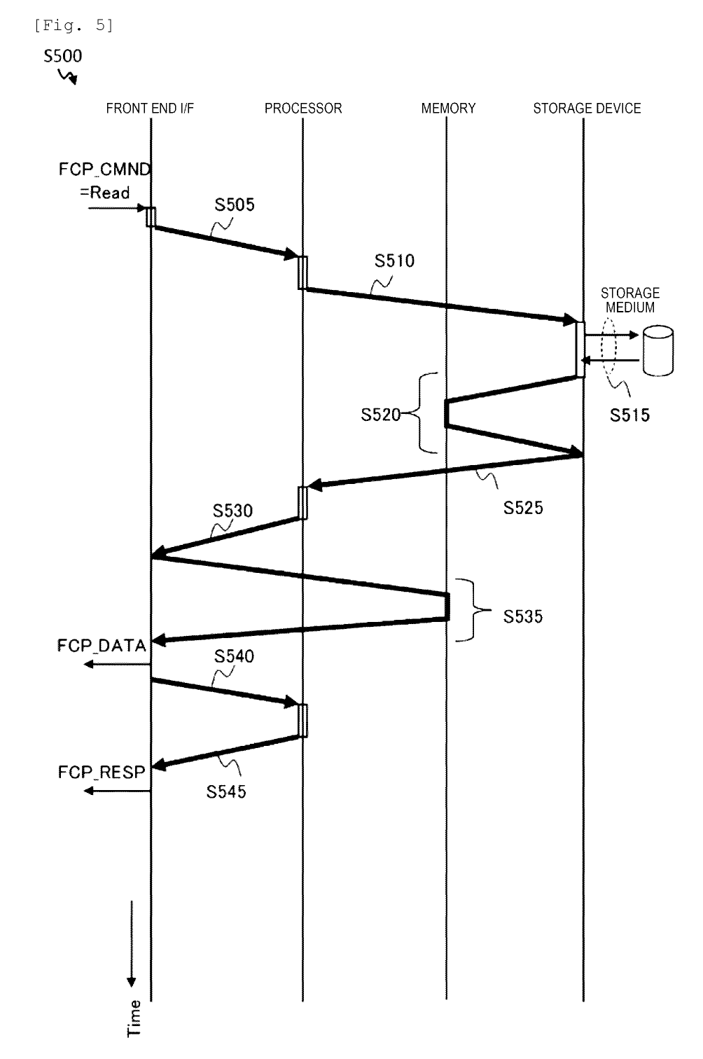

Specific examples of the host IO synchronization processing, the unconstrained host IO asynchronous processing, and the constrained host IO asynchronous processing as described above will be described with reference to FIGS. 4 and 5.

FIG. 4 illustrates a flow of the write processing performed in the storage apparatus 110 that receives a write command (“FCP_CMND=Write” in FIG. 4) from the host computer 105.

In the storage apparatus 110, if the front end interface 116 receives the write command, the front end interface 116 first notifies the processor 120 that the write command is received (S405). The notification transmitted by the front end interface 116 to the processor 120 is a notification for informing the processor 120 that the front end interface unit 116 starts to write data (write data) of a write target transmitted from the host computer 105 to the memory 122.

In a case where a state in which the write data can be written to the memory 122 is provided, the processor 120 received the notification transmits a response to that effect to the front end interface 116 (S410). Thus, the response is transmitted to the host computer 105 via the front end interface 116 (“XFER_RDY” in FIG. 4).

Thereafter, if the write data is transmitted from the host computer 105 received the response (“FCP_DATA” in FIG. 4), the write data is received by the front end interface 116, and the received write data is transferred to the memory 122 under control of the processor 120 to be written to a cache memory area of the memory 122 (S415). In addition, if the write data is written to the cache memory area, the memory 122 transmits a response according to the write data to the front end interface 116.

If transferring all the received write data to the memory 122 is ended, the front end interface 116 notifies the processor 120 that writing of the write data is ended (S420).

If the notification is received, the processor 120 transmits a completion notification to the front end interface 116 so as to notify the host computer 105 that write processing of the write data is completed (S425). Thus, the completion notification is transmitted to the host computer 105 via the front end interface 116 (“FCP_RESP” in FIG. 4).

Thereafter, the processor 120 starts destage processing of storing the write data stored in the memory 122 in the storage device 126 at a predetermined opportunity. Then, the processor 120 gives a command to the effect that the write data stored in the memory 122 has to be stored in the buffer 250 of the storage device 126, to the corresponding storage device 126 (S430).

If the command is received, the storage device 126 transmits a write data acquisition command for acquiring the write data stored in the memory 122 to the memory 122 (S435). If the write data acquisition command is received, the memory 122 transmits the requested write data to the storage device 126 (S440).

Thus, the storage device 126 received the write data stores the received write data in the buffer 250, and thereafter stores the write data stored in the buffer 250 in the storage medium 270 (S445). If storing the write data in the storage medium 270 is ended by doing so, the storage device 126 gives a completion notification to that effect to the processor 120 (S450). Thereby, a series of processing ends.

In the series of processing described above, the processing from step S405 to step S425 is the host IO synchronization processing that is performed in synchronization with the write command from the host computer 105, and the processing from step S430 to step S450 is performed asynchronously with the write command, and is processing that does not have influence on a response performance of the storage apparatus 110 as viewed from the host computer 105 in a case where the remaining capacity of the memory 122 is sufficient, thereby, being classified as the unconstrained host IO asynchronous processing.

Meanwhile, FIG. 5 illustrates a flow of read processing performed in the storage apparatus 110 received a read command (“FCP_CMND=Read” in FIG. 5) from the host computer 105.

In the storage apparatus 110, if the front end interface 116 receives the read command, the front end interface 116 first analyzes content of the read command and notifies the processor 120 of the analysis result (S505).

The processor 120 received the notification determines whether or not requested data exists in the cache memory area of the memory 122, and when the data is not stored in the cache memory area, a command to the effect that the data has to be transferred is given to the corresponding storage device 126 (S510).

The storage device 126 received the command reads the requested data from the storage medium 270 (S515), stages the read data in the cache memory area of the memory 122 (S520), and if the staging is completed, the completion notification to that effect is transmitted to the processor 120 (S525).

If the completion notification is received, the processor 120 transmits a command to the effect that the data staged in the cache memory area of the memory 122 has to be read, to the front end interface 116 (S530).

If the command is received, the front end interface 116 accesses a specific address of the cache memory area of the memory 122, reads target data (S535), and transfers the data to the host computer 105 as the read data “FCP_DATA” of FIG. 5). In addition, if transferring the requested data to the host computer 105 ends, the front end interface 116 transmits a completion notification to that effect to the processor 120 (S540).

Then, the processor 120 received the completion notification confirms that there is no error in a series of processing described above, based on a guarantee code of data and the like, and transmits a request to the front end interface 116 so as to transmit a response to the effect that the read processing is normally ended to the host computer 105 (S545).

Thus, the front end interface 116 transmits a completion notification (“FCP_RESP” in FIG. 5) to the effect that the read processing of the requested read data is completed to the host computer 105 in response to the request. Thereby, a series of read processing ends.

A series of processing described above is the host IO synchronization processing that is performed in synchronization with the read command from the host computer 105. In addition, for example, in a case where the storage apparatus 110 performs read ahead processing in accordance with processing content of the read processing at that time thereafter, the read ahead processing is classified into the constrained host IO asynchronous processing.

### (1-3) Command Processing Method According to the Present Embodiment

Next, a method of processing a command from the storage controller 115 employed in the storage apparatus 110 will be described.

The present command processing method is a method in which a plurality of command queues of which priorities are differently set in the memory 122 or the like of the storage controller 115 are generated to correspond to the respective storage devices 126, the processor 120 sequentially posts (stores) commands in the command queue corresponding to the priority preset in the command, and the commands stored in the command queue with high priority among the commands stored in the respective command queues are preferentially processed on the storage device 126 side.

Here, “priority of a command” means the degree of rapidity of processing required in the processing of the command, and higher priority is set for the command in which faster processing is obtained. Priorities of each command are preset according to contents thereof, respectively. For example, in a case of the host synchronization processing, the constrained host IO asynchronous processing, and the unconstrained host IO asynchronous processing, the highest priority is set for the command corresponding to the host IO synchronization processing, the second highest priority is set for the command corresponding to the constrained host IO asynchronous processing, and the lowest priority is set for the command corresponding to the unconstrained host IO asynchronous processing.

Therefore, in the example of the command corresponding to the host IO synchronization processing, the command corresponding to the constrained host IO asynchronous processing, and the unconstrained host IO asynchronous processing, the command corresponding to the host IO synchronization processing is posted to a command queue with the highest priority, the command corresponding to the constrained host IO asynchronous processing is posted to a command queue with the second highest priority, and the command corresponding to the unconstrained host IO asynchronous processing is posted to a command queue with the lowest priority.

Meanwhile, on the storage device 126 side, a processing period (round which will be described below) is divided for each priority of the command queue, and during a certain processing period of the priority, a command is fetched from the command queue in which the priority is set to be processed. The storage device 126 repeatedly performs the processing for each priority and in the sequence of priority. At this time, the storage device 126 fetches and processes commands from many command queues in accordance with a certain rule in the processing period of higher priority such that more commands with higher priority can be processed more.

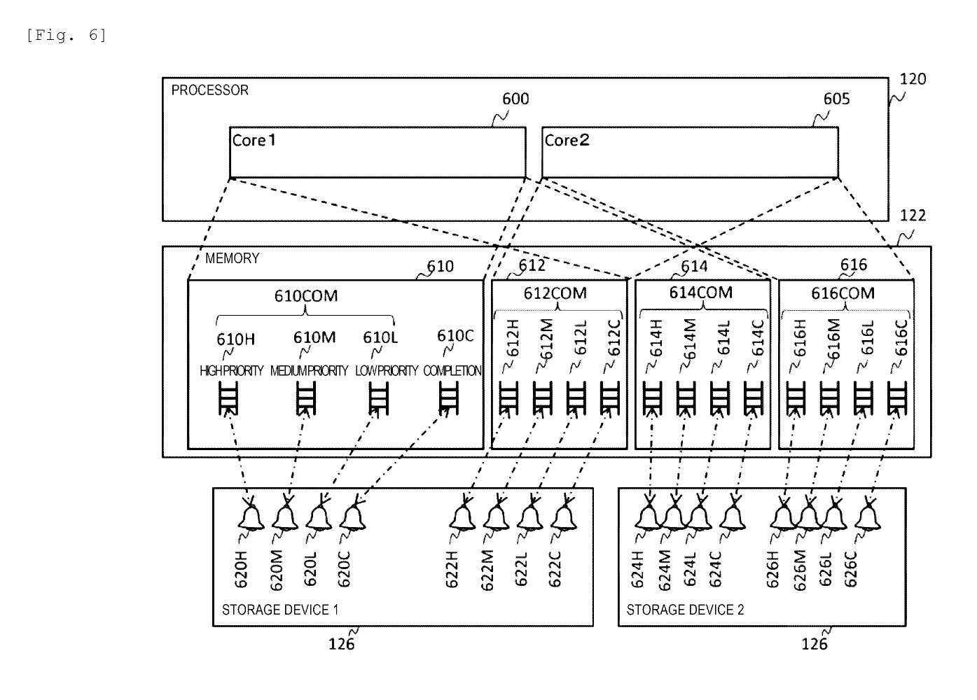

Hereinafter, the command processing method according to the present embodiment will be described with reference to FIGS. 6 to 15.

### (1-3-1) Logical Connection Relationship Between Processor and Storage Device

FIG. 6 illustrates a logical connection relationship between the processor 120 and the storage device 126 according to the present embodiment. Generally, the processor 120 includes a plurality of processor cores. In FIG. 6, the processor 120 includes two processor cores 600 and 605.

The memory 122 is provided with a plurality of queues prepared in association with the respective storage devices 126 for the respective processor cores 600 and 605. In FIG. 6, the number of processor cores 600 and 605 is two and the number of storage devices 126 is two, and thereby, a total of four queue groups 610, 612, 614, and 616 are provided. The number of queue groups 610, 612, 614, and 616 can be obtained by multiplying the number of processor cores 600 and 605 by the number of storage devices 126.

The queue groups 610, 612, 614, and 616 are configured with two types of queues having different roles. The first queue is command queues 610COM, 612COM, 614COM, and 616COM for posting commands when the processor cores 600 and 605 request the storage device 126 to read or write data stored in the storage medium 270. The second queue is completion queues 610C, 612C, 614C, and 616C for posting completion of the commands posted in the command queues 610COM, 612COM, 614COM, and 616COM. In the following, it will be described that the command queues 610COM, 612COM, 614COM, and 616COM and the completion queues 610C, 612C, 614C, and 616C have a so-called ring buffer structure, but a buffer structure other than the ring buffer structure may be used.

A command or a completion notification posted in the respective queues (which are the command queues 610COM, 612COM, 614COM, and 616COM and the completion queues 610C, 612C, 614C, and 616C, and the same applies hereinafter) is managed by two pointers. The two pointers are a head pointer and a tail pointer. The head pointer is a pointer indicating a head of a queue, and the tail pointer is a pointer indicating an end of the queue. That is, in a case where the queue has a ring buffer structure, if the head pointer and the tail pointer do not coincide with each other, it indicates that the queue is empty, and if the head pointer and the tail pointer coincide with each other, it indicates that the queue is full. If the queue becomes full, it is not possible to post a new command or a completion notification.

An entity (a specific example will be described below) that posts a command or a completion notification in a queue posts a new command or completion notification with reference to the tail pointer in the queue and increments the tail pointer. An entity that fetches a command or a completion notification from the queue fetches a new command or completion notification with reference to the head pointer in the queue and increments the head pointer.

An entity that posts commands in the command queues 610COM, 612COM, 614COM, and 616COM is the processor 120, and an entity that posts completion notifications in the completion queues 610C, 612C, 614C, and 616C is the storage device 126. In addition, an entity that fetches commands of the command queues 610COM, 612COM, 614COM, and 616COM is the storage device 126, and an entity that fetches the completion notifications of the completion queues 610C, 612C, 614C, and 616C is the processor 120.

As illustrated in FIG. 6, the respective queue groups 610, 612, 614, and 616 have three command queues (610H, 610M, 610L), (612H, 612M, 612L), (614H, 614M, 614L), and (616H, 616M, 616L) in which priorities are set, as the command queues 610COM, 612COM, 614COM, and 616COM, respectively. As the priorities, “high”, “medium” or “low” is set. Accordingly, one queue group 610, 612, 614, and 616 is configured with four queues. In FIG. 6, a command queue whose priority is “high” is referred to as “xxxH (High)”, a command queue whose priority is “medium” is referred to as “xxxM (medium)”, a command queue whose priority is “low” is referred to as “xxxL (Low)”, and a completion queue is referred to as “xxxC (Completion)”.

In addition, the four queue groups 610, 612, 614, and 616 are associated with the processor cores 600 and 605 and the storage device 126, respectively. By doing so, access to any storage device 126 from any processor cores 600 and 605 can be performed without exclusion. In FIG. 6, the queue group 610 can be set to a queue group for the processor core 600 corresponding to the storage device 126 called a “storage device 0”. In the same manner, the queue group 612 can be set to a queue group for the processor core 605 corresponding to the storage device 126 called the “storage device 0”, the queue group 614 can be set to a queue group for the processor core 600 corresponding to the storage device 126 called a “storage device 1”, and the queue group 616 can be set to a queue group for the processor core 605 corresponding to the storage device 126 called the “storage device 1”.

When a command or a completion notification is posted in the command queues 610COM, 612COM, 614COM, and 616COM or the completion queues 610C, 612C, 614C, and 616C, a doorbell interrupt (hereinafter, referred to as a doorbell) for instructing interrupt processing as a means for notifying a communication partner is used. The tail pointer of the corresponding queue is written to the doorbell. The communication partner fetches and processes a command or a completion notification written in response to the writing. The doorbells are prepared for each queue. That is, the doorbells are provided in a form in which the doorbell for the command queue 610H is a doorbell 620H, the doorbell for the command queue 610M is a doorbell 620M, the doorbell for the command queue 610L is a doorbell 620L, and the doorbell for the completion queue 610C is a doorbell 620C, . . . , for each queue.

The reason why doorbells 620C, 622C, 624C, and 626C are required for the completion queues 610C, 612C, 614C, and 616C is that the head pointers are updated, and is to explicitly represent that the commands and the like stored in the completion queues 610C, 612C, 614C, and 616C are processed for an NVMe controller.

While not illustrated, the memory 122 (FIG. 1) in each storage controller 115 includes a cache memory area that stores user data received from the host computer 105 and a control memory area that stores control data in the storage apparatus 110. For example, control data, configuration data, directory data, and the like of the storage apparatus 110 are stored in the control memory area. For example, a buffer area used by the front end interface 116 or the storage device 126 is allocated to the cache memory area.

### (1-3-2) Queue Generation Processing

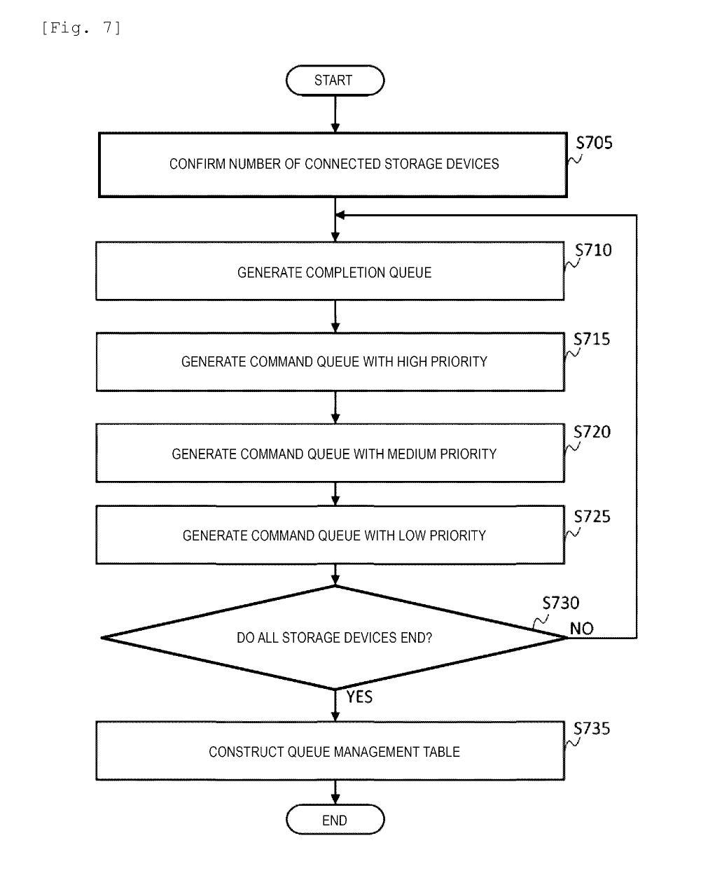

FIG. 7 illustrates a specific processing sequence of queue generation processing of generating the above-described command queue and completion queue on the memory 122 in the storage apparatus 110. The queue generation processing is processing performed by the processor 120 based on a queue generation program 123 (FIG. 1) stored in the memory 122, and a generation destination of the queue is the memory 122. In a case where there are a plurality of processors 120 or a plurality of processor cores in the storage apparatus 110, the processors 120 or the processor cores perform the queue generation processing, but in the following, a processing entity will be described as the processors 120 for the time being.

If the storage apparatus 110 is activated, the processor 120 starts the queue generation processing illustrated in FIG. 7, and first confirms the number of storage devices 126 connected to the storage controller 115 (S705) with reference to configuration information stored in the control memory area of the memory 122. By grasping the number of storage devices 126 in this way, the number of queue groups that are required can be known. The number of queue groups can be obtained from the number of processor cores and the number of storage devices 126 as described above in FIG. 6. It is assumed that the processor 120 grasps the number of processor cores thereof in advance.

Subsequently, the processor 120 sequentially generates a completion queue for each processor core for one storage device 126, a command queue with a “high” priority, a command queue with a “medium” priority, and a command queue with a “low” priority (S710 to S725). Thereby, queue groups corresponding to the number of processor cores for one storage device 126 are generated. The completion queue is generated first because an identifier for identifying the completion queue is required for one of the arguments required when the command queue is generated. For example, a protocol such as NVM Express and Infiniband is configured with a specification which requires setting of information such as a completion queue identifier (CQID) in a case of NVM Express and information such as send_cq in a case of Infiniband as an argument necessary when a completion queue (defined as Completion Queue together in standard) is generated.

Next, the processor 120 determines whether or not the processing of the above-described steps S710 to S725 is repeated as many times as the number of storage devices 126 confirmed at step S705 (S730). If a negative result is obtained in the determination, the processor 120 returns to step S710, and thereafter, repeats the processing from step S710 to step S730 until a positive result is obtained in step S730.

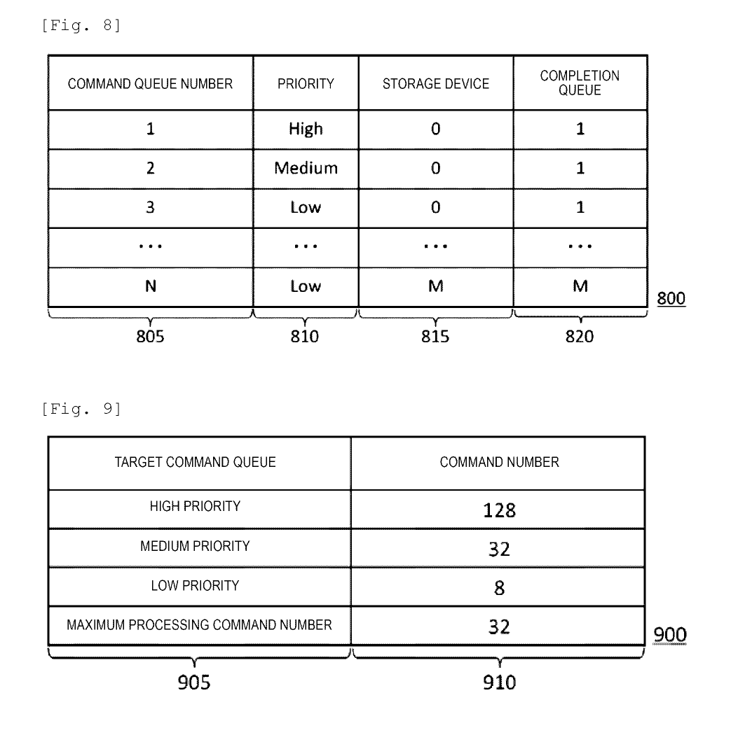

If a positive result is obtained in step S730 by ending generation of all necessary queue groups in due course, the processor 120 constructs a queue management table 800 as illustrated in FIG. 8 for managing the queue (S735), and thereafter, ends the queue generation processing.

In the present embodiment, only one completion queue is not generated in step S710 of the above-described queue generation processing, but a merit of this is that cost (load, processing time, and the like) at the time of posting a command in a command queue, for example, cost (load, processing time) required for confirming the completion queue performed by I/O processing (step S300) is reduced.

However, in a case where a completion notification of a plurality of command queues is managed by one completion queue, if any error occurs in the completion queue, the completion queue needs to be reset in the above-described NVM Express and Infiniband. If the completion queue is reset, the completion notification posted in the queue is naturally cleared, and thus, error processing has to be performed while taking a correspondence relationship with commands posted in the plurality of command queues. Therefore, for example, the same number of completion queues as the command queues may be generated in step S710 of the queue generation processing. By doing so, for example, even if any type of error occurs in the completion queue, it is possible to localize an influence on the command queue associated therewith.

However, in a case where the same number of completion queues as the command queues is generated, the number of queues that have to be maintained increases, which causes a problem in which a memory capacity is consumed. Thus, in this case, since the memory capacity is finite, the cache memory area and the like of the memory 122 has to be reduced. For example, if the cache memory capacity is reduced, system performance is also influenced.

Therefore, a hybrid method of the above approach may be adopted. For example, one completion queue maybe associated with a command queue with a “high” priority, and one completion queue may be associated with each of the command queues with a “medium” priority and a “low” priority. By doing so, for example, it is possible to reduce the number of completion queues to be checked by an I/O processing program, and to alleviate tightness of the memory capacity.

A generation destination of the queue is the memory 122 in the queue generation processing of FIG. 7, but the queue may be generated in, for example, the RAM 240 or the buffer 250 in the storage device 126 illustrated in FIG. 2. Alternatively, the queue may be generated separately in the memory 122, and the RAM 240 or the buffer 250 in the storage device 126, depending on the priority of the command queue. By setting the generation destination of the queue to the storage device 126, it is advantageous that time can be reduced until the storage device 126 fetches a command from the command queue and starts to perform processing and a response performance is effectively suppressed.

### (1-3-3) Configuration of Queue Management Table

FIG. 8 illustrates a configuration example of the above-described queue management table 800. The queue management table 800 is a table for managing the priority of the command queue generated in the above-described queue generation processing, the corresponding storage device 126, and the corresponding completion queue, and is stored in the RAM 240 of the storage device 126 or in the buffer 250.

The queue management table 800 is configured to include a command queue number field 805, a priority field 810, a storage device field 815, and a completion queue field 820.

In the command queue number field 805, unique identifiers (command queue numbers) respectively given to the respective command queues generated in the queue generation processing are stored.

In the priority field 810, priorities allocated to the corresponding command queues are stored. In the present embodiment, in a case where the priority allocated to the corresponding command queue is “high”, “High” is stored, if the priority is “medium”, “Medium” is stored, and if the priority is “low”, “Low” is stored.

The identifier of the storage device 126 associated with the corresponding command queue is stored in the storage device field 815, and the identifier (completion queue number) of the completion queue associated with the corresponding command queue is stored in the completion queue field 820.

Accordingly, the example of FIG. 8 represents that each of the command queues having the command queue numbers of “1” to “3” is a command queue with the “High”, “Medium” or “Low” priority generated in association with the storage device 126 whose identifier is “0” and is associated with the completion queue having a completion queue number of “1”.

In addition, it can be seen from FIG. 8 that the queue group associated with the storage device 126 whose identifier is “0” is configured by three command queues having the command queue numbers of “1” to “3” respectively and one completion queue having the completion queue number of “1”.

### (1-3-4) Configuration of Maximum Command Number Management Table

FIG. 9 illustrates a configuration of the maximum command number management table 900. The maximum command number management table 900 is a table that defines the number of commands fetched by the storage device 126 from each command queue with priority of “high”, “medium” or “low”. The maximum command number management table 900 is configured to include a target command queue field 905 and a command number field 910.

The type of priority such as “high priority”, “medium priority”, and “low priority” and information indicating that a line thereof is a line corresponding to the “maximum processing command number” are stored in the target command queue field 905. The “high priority” corresponds to the priority of “high”, the “medium priority” corresponds to the priority of “medium”, and the “low priority” corresponds to the priority of “low”. This also applies to the following description.

In addition, the number of commands corresponding to elements stored in the target command queue field 905 is stored in the command number field 910. In this case, meaning of the number of commands differs depending on contents of the target command queue field 905.

That is, in a case where the element of the target command queue field 905 is the “high priority”, the “medium priority” or the “low priority”, the meaning of the number of commands stored in the command number field 910 indicates the maximum number of commands that can be fetched from a command queue of the priority in each round of arbitration of the transmission queue performed by the storage device 126. In addition, in a case where an element of the target command queue field 905 is a “maximum processing command number”, meaning of the number of commands stored in the command number field 910 represents the maximum number of commands that can be processed from one command queue.

Here, “arbitration of transmission queue” means that the storage device 126 selects a command queue in which a command to be processed is stored. In the present embodiment, at the time of the arbitration, the command queue and commands are selected with reference to the maximum command number management table 900. In NVM Express, arbitrations are performed for each priority. Hereinafter, this is called a round or an arbitration round.

For example, in a round whose priority is “high”, the arbitration is performed for the command queue of the “high priority”, and a command to be processed is selected from among the commands respectively stored in the respective command queues of the “high priority”. In this case, in the example of FIG. 9, the maximum number of commands that can be processed in one round is “128” and the maximum number of processing commands is “32” for the “high priority”. Accordingly, in the round whose priority is “high”, commands are sequentially selected by, for example, a round robin method from each command queue set to the “high priority”, until maximum “32” commands become a total of “128”.

In addition, in a round whose priority is “medium”, arbitration is performed for the command queue of the “medium priority”, and a command to be processed is selected from among the commands respectively stored in the respective command queues of the “medium priority”. In the example of FIG. 9, the maximum number of commands that can be processed in one round is “32” and the maximum number of processing commands is “32” for the “medium priority”. Accordingly, in the round whose priority is “medium”, commands are sequentially selected by, for example, a round robin method from each command queue set to the “medium priority”, until maximum “32” commands become a total of “32”.

Furthermore, in the round of the “low” priority, arbitration is performed for the command queue of the “low priority”, and the command to be processed is selected from among the commands respectively stored in the respective command queues of the “low priority”. In the example of FIG. 9, the maximum number of commands that can be processed in one round is “8” and the maximum number of processing commands is “32” for the “low priority”. Accordingly, in the round whose priority is “low”, commands are sequentially selected by, for example, a round robin method from each command queue set to the “low priority”, until maximum “32” commands become a total of “8”.

### (1-3-5) Arbitration Processing

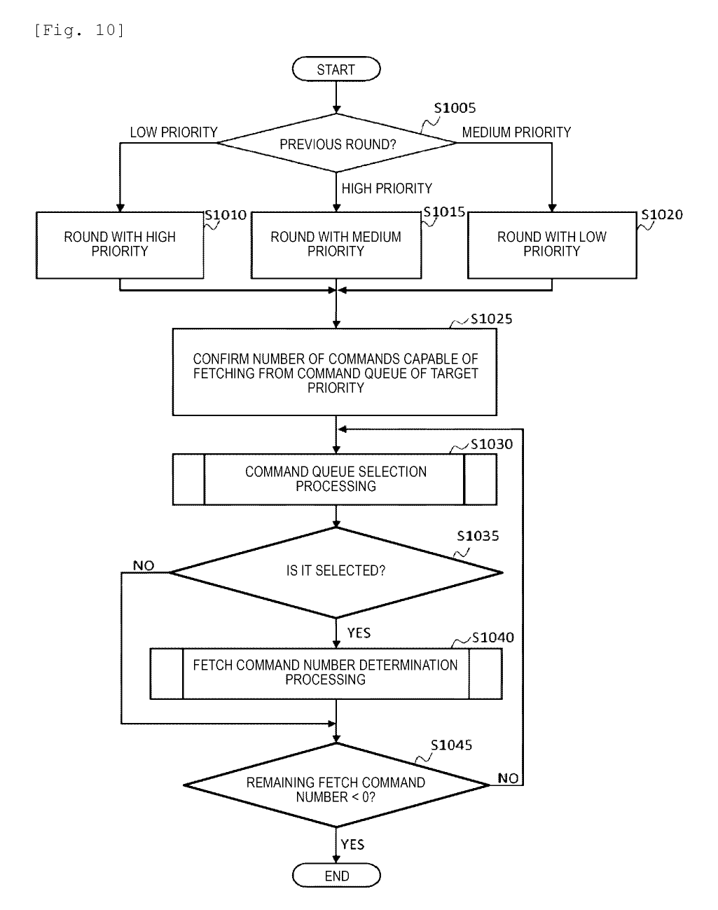

FIG. 10 illustrates a specific processing sequence of the arbitration processing. The arbitration processing is repeatedly performed by the arbitration processing unit 220 (FIG. 2) of the storage device 126. The arbitration processing unit 220 performs the arbitration processing by cooperating with the command queue selection unit 215 (FIG. 2) and the fetch command determination processing unit 225 (FIG. 2) as necessary.

Actually, if the arbitration processing illustrated in FIG. 10 starts, the arbitration processing unit 220 first determines whether or not a previous round is a round for any one priority among the “high priority”, the “medium priority”, and the “low priority” (S1005).

In a case where the previous round is a round targeting the “low priority”, the arbitration processing unit 220 determines a current target priority (hereinafter, referred to as a target priority) as the “high priority” (S1010), in a case where the previous round is a round targeting the “high priority”, the arbitration processing unit 220 determines the current target priority as the “medium priority” (S1015), and in a case where the previous round is a round targeting the “medium priority”, the arbitration processing unit 220 determines the current target priority as the “low priority” (S1020).

In a case of the present embodiment, in order to set an initial state of the round as a round for a command queue with the “high priority”, determination results that the previous round is a round targeting the “low priority” are obtained in step S1005 of the arbitration processing which is performed at first.

Subsequently, the arbitration processing unit 220 confirms the maximum number of commands that can be fetched from the command queue with the target priority with reference to the fetch command number management table 900 (S1025).

The maximum command number management table 900 may be stored in the memory 122 of the storage controller 115 or may be stored in the RAM 240 or the buffer 250 of the storage device 126. However, it is preferable that the maximum command number management table 900 is stored in the RAM 240 or the buffer 250 of the storage device 126. This is because, in a case where the maximum command number management table 900 exists in the same storage device 126 as the arbitration processing unit 220, access time to the maximum command number management table 900 performed by the arbitration processing unit 220 can be reduced.

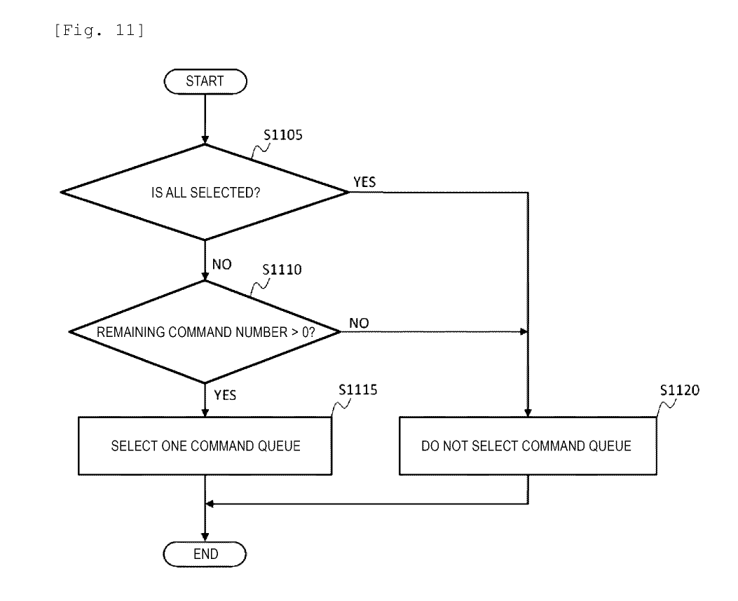

Subsequently, the arbitration processing unit 220 activates the command queue selection unit 215 (FIG. 2) and executes the command queue selection processing to select one command queue that fetches a command from among the command queues of the target priority (S1030). Details of the command queue selection processing will be described with reference to FIG. 11.

Thereafter, the arbitration processing unit 220 determines whether or not one command queue can be selected by the command queue selection unit 215 in the command queue selection processing in step S1030 (S1035). If a negative result is obtained in the determination (S1035: NO), the arbitration processing unit 220 proceeds to step S1045.

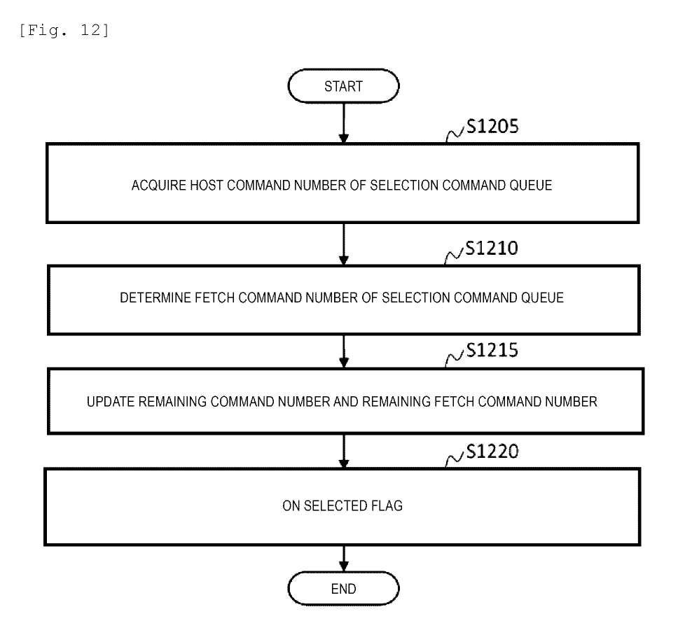

In contrast to this, if a positive result is obtained in the determination of step S1035 (S1035: YES), the arbitration processing unit 220 activates the fetch command number determination processing unit 225 (FIG. 2) and executes the fetch command number determination processing of determining the number of commands to be fetched from the command queue selected in step S1030 to be performed (S1040). Details of the fetch command number determination processing will be described with reference to FIG. 12.

Subsequently, the arbitration processing unit 220 determines whether or not each command queue of the arbitration target and all the commands to be respectively fetched from the command queues are completely determined (S1045).

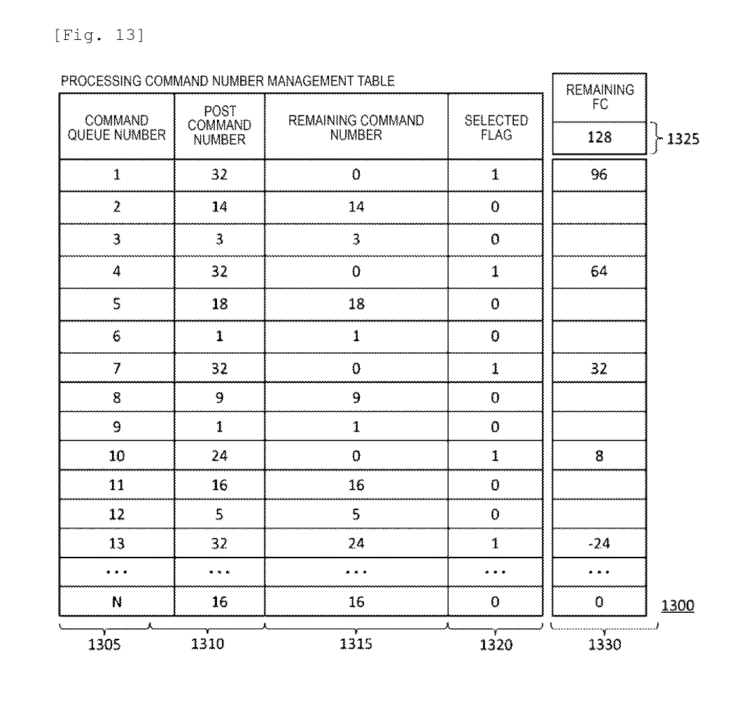

In a process in which step S1030 to step S1045 are repeatedly performed as will be described below, the determination is made by determining whether or not a total value of the number of commands respectively determined in step S1040 is equal to or larger than the maximum number of commands (“128” for “high priority”, “32” for “medium priority”, and “8” for “low priority”) that can be processed in one round defined in the maximum command number management table 900 for the target priority. More specifically, the arbitration processing unit 220 makes the determination by determining whether or not the number of remaining fetch commands stored in the remaining fetch command number field 1330 (FIG. 13) of the processing command number management table 1300 which is described below (FIG. 13) is smaller than zero.

If a negative result is obtained in the determination, the arbitration processing unit 220 returns to step S1030, and thereafter, repeats processing of step S1030 to step S1045 until a positive result is obtained in step S1045 while sequentially changing a command queue selected in the command queue selection processing of step S1030 to another command queue.

If the arbitration processing unit 220 obtains a positive result in step S1045 by finally determining the command queue that fetches a command by repeating the processing of step S1030 to step S1045 and the number of commands fetched from the command queue, the arbitration processing ends.

Thus, thereafter, the storage device 126 fetches commands corresponding to the number of fetch commands respectively determined for each command queue from each command queue selected as a command fetch target in the arbitration process and processes the commands in accordance with the processing results of the arbitration processing.

If the above-described arbitration processing ends, the arbitration processing unit 220 immediately starts the next arbitration processing. In this case, if the next arbitration processing starts, the arbitration processing unit 220 determines which priority among the “high priority”, the “medium priority”, and the “low priority” the previous round is for as described in step S1005, and performs the following processing after step S1025 by setting a current target priority to the “high priority” in a case where the previous round is a round targeting the “low priority”, by setting the current target priority to the “medium priority” in a case where the previous round is a round targeting the “high priority”, and by setting the current target priority to the “low priority” in a case where the previous round is a round targeting the “medium priority”.

Accordingly, during an operation of the storage apparatus 110, the arbitration processing is repeatedly performed while the target priorities are sequentially switched in the order of the “high priority”, the “medium priority”, and the “low priority”.

### (1-3-6) Processing Command Number Management Table

FIG. 13 illustrates a configuration example of the processing command number management table 1300 used in the command queue selection processing which will be described below with reference to FIG. 11 and the fetch command number determination processing which will be described below with reference to FIG. 12.

The processing command number management table 1300 is a table used for managing the command queue selected in the command queue selection processing (FIG. 11) and the number of commands fetched from the command queue determined in the fetch command number determination processing, and is configured to include a command queue number field 1305, a post command number field 1310, a remaining command number field 1315, a selected flag field 1320, and remaining fetch command number fields 1325 and 1330.

Command queue numbers respectively given to each command queue generated by the queue generation processing described above with reference to FIG. 7 are stored in the command queue number field 1305.

In addition, the number of commands (hereinafter, referred to as the number of posted commands) posted in the corresponding command queue is stored in the post command number field 1310. The number of posted commands can be confirmed by using a head pointer and a tail pointer in the corresponding command queue. That is, the number of posted commands in the command queue is equal to a difference between the head pointer and the tail pointer.

The number of commands (hereinafter, referred to as the number of remaining commands) which are not fetched among the commands posted in the corresponding command queue is stored in the remaining command number field 1315. The number of remaining commands is selected by the corresponding command queue in step S1030 of the arbitration processing (FIG. 7), and is updated when the number of commands to be fetched which are determined by the fetch command number determination processing of step S1040 performed thereafter for the command queue. Specifically, the number of remaining commands is updated to the number obtained by subtracting the number of commands to be fetched which is determined in the fetch command number determination processing from the number of posted commands.

A flag (hereinafter, this is referred to as a selected flag) indicating whether or not the command queue is selected as a command queue that fetches a command in the command queue selection processing performed in step S1030 of the arbitration processing performed until now (FIG. 7) is stored in the selected flag field 1320. The selected flag is set to “0” in an initial state and is updated to “1” when the corresponding command queue is selected as a command queue that fetches a command in the command queue selection processing.

For example, in a case where the selected flags of all the command queues become “1”, this means that all commands of the command queue are fetched. In this case, all the selected flags are initialized (return to “0”) during a round of arbitration or at the start of round.

A purpose of providing the selected field 1320 is to fairly perform fetch of a command between command queues. For example, in a case where a command is not fetched from a certain command queue due to a certain reason, processing time of the command posted in the command queue increases. Therefore, by setting the selected flag to ON (set to “1”) for the command queue selected once, it is possible to easily recognize the command queue in which the command is not fetched yet, and to fairly fetch commands from all the command queues.

The number of commands that can be processed in one round of a target priority at that time is stored in the remaining fetch command number field 1325. The number of commands is read from the maximum command number management table 900.

In addition, In the process of repeatedly processing step S1030 to step S1045 of the arbitration processing of FIG. 7, the corresponding command queue is selected by the command queue selection processing of step S1030, and, in a case where the number of fetch commands stored in the command queue is determined in the fetch command number determination processing of subsequent step S1040, the number of remaining commands (hereinafter, referred to as the number of remaining fetch commands) that can be further fetched in a current round is stored in the remaining fetch command number field 1330. If the number of remaining fetch commands is exhausted, it means that commands cannot be fetched anymore in the round. Thus, this makes the round end.

In the processing command number management table 1300, the number of posted commands of each command queue is updated to the number of commands posted in the command queue at that time by the arbitration processing unit 220, for example, when the arbitration processing unit 220 starts the arbitration processing. In addition, the selected flag is set to ON (“1”) when the command queue selection unit 215 selects the corresponding command queue in the command queue selection processing (step S1030 in FIG. 7). Furthermore, when the fetch command number determination unit 225 determines the number of fetch commands for the corresponding command queue by using the fetch command number determination processing (step S1040 in FIG. 7), the number of remaining commands and the number of remaining fetch commands are updated by the fetch command number determination unit 225 in accordance with the determination.

### (1-3-7) Command Queue Selection Processing

FIG. 11 illustrates specific processing contents of the command queue selection processing performed by the command queue selection unit 215 in step S1030 of the arbitration processing described above with reference to FIG. 10.

If being activated by the arbitration processing unit 220, the command queue selection unit 215 first determines whether or not the selected flags of all the command queues in which the set priority is a target priority at that time among the command queues registered in the processing command number management table 1300 (FIG. 13) are set to ON (“1”), with reference to the queue management table 800 (FIG. 8) (S1105). If a positive result is obtained by the determination, the command queue selection unit 215 proceeds to step S1120.

In contrast to this, if a negative result is obtained by the determination in step S1110, the command queue selection unit 215 determines whether the number of remaining fetch commands of the target priority at that time is larger than zero with reference to the remaining fetch command number field 1330 in the processing command number management table 1300 (S1110).

If a negative result is obtained by the determination, the command queue selection unit 215 does not select a command queue in a current arbitration round (S1120), and thereafter ends the command queue selection processing. Accordingly, in this case, a negative result is obtained in step S1035 of the arbitration processing (FIG. 7).

In contrast to this, if a positive result is obtained by the determination of step S1110, the set priority is the target priority at that time, and the command queue selection unit 215 selects one command queue from among the command queues in which the selected flag is set to “0” as a command fetch target of the command queue (S1115), and thereafter, ends the command queue selection processing. Accordingly, in this case, a positive result is obtained in step S1035 of the arbitration processing (FIG. 7).

### (1-3-8) Fetch Command Number Determination Processing

FIG. 12 illustrates specific processing contents of the fetch command number determination processing performed by the fetch command number determination processing unit 225 (FIG. 2) in step S1040 of the arbitration processing described above with reference to FIG. 10.

If being activated by the arbitration processing unit 220, the fetch command number determination processing unit 225 first acquires the number of commands (the number of posted commands) to be posted in the command queue (hereinafter, this is referred to as a selection command queue) selected in the immediately preceding command queue selection processing (FIG. 11), with reference to the processing command number management table 1300 (FIG. 13) (S1205).

Subsequently, the fetch command number determination processing unit 225 determines the number of commands (the number of fetch commands) to be fetched from the selection command queue (S1210).

Specifically, the fetch command number determination processing unit 225 determines the maximum number of processing commands as the number of fetch commands of the selection command queue, in a case where the number of posted commands acquired in step S1205 is equal to or larger than the maximum number (“32” in FIG. 9) of processing commands registered in the maximum command number management table 900, and the number of remaining fetch commands in the round stored in the remaining fetch command number field 1330 in the processing command number management table 1300 is equal to or larger than the maximum number of processing commands.

In addition, the fetch command number determination processing unit 225 determines the number of posted commands acquired in step S1205 as the number of fetch commands of the selection command queue, in a case where the number of posted commands acquired instep S1205 is smaller than the maximum number of processing commands, and the number of remaining fetch commands in the round stored in the remaining fetch command number field 1330 in the processing command number management table 1300 is equal to or larger than the number of posted commands.

Furthermore, the fetch command number determination processing unit 225 determines the number of remaining fetch commands as the number of fetch commands of the selection command queue, in a case where the number of remaining fetch commands in the round stored in the remaining fetch command number field 1330 in the processing command number management table 1300 is smaller than the maximum number of processing commands, and the number of remaining fetch commands is smaller than the number of posted commands acquired in step S1205.

Furthermore, the fetch command number determination processing unit 225 determines the number of posted commands acquired in step S1205 as the number of fetch commands of the selection command queue, in a case where the number of remaining fetch commands in the round stored in the remaining fetch command number field 1330 of the processing command number management table 1300 is smaller than the maximum number of processing commands, and the number of remaining fetch commands is larger than the number of posted commands acquired in step S1205.

Next, the fetch command number determination processing unit 225 updates the remaining command number field 1315 (FIG. 13) and the remaining fetch command field 1330 corresponding to the selection command queue in the processing command number management table 1300, based on the determination result of step S1210 (S1215).

Specifically, the fetch command number determination processing unit 225 stores the calculation result obtained by subtracting the number of fetch commands determined instep SP1210 from the number of commands stored in the post command number field 1310 corresponding to a selection command queue in the processing command number management table 1300, in the remaining command number field 1315 (FIG. 13) corresponding to the selection command queue.

In addition, the fetch command number determination processing unit 225 stores a value obtained by subtracting the number of fetch commands determined in step S1210 from the latest number of remaining fetch commands stored in the remaining fetch command number field 1330 corresponding to a selection command queue in the processing command number management table 1300, in the remaining fetch command number field 1330 corresponding to the selection command queue. However, in a case where the number of updated commands stored in the post command number field 1310 corresponding to the selection command queue in the processing command number management table 1300 is not zero, the calculation result obtained by subtracting the maximum number of processing commands from the latest number of remaining fetch commands is stored in the remaining fetch command number field 1330 corresponding to the selection command queue.

Subsequently, the fetch command number determination processing unit 225 sets the selected flag stored in the selected flag field 1320 corresponding to the selection command queue in the processing command number management table 1300 to ON (“1”) (S1220). Thereafter, the fetch command number determination processing unit 225 ends the fetch command number determination processing.

### (1-3-9) One Example of Fetch Command Number Determination

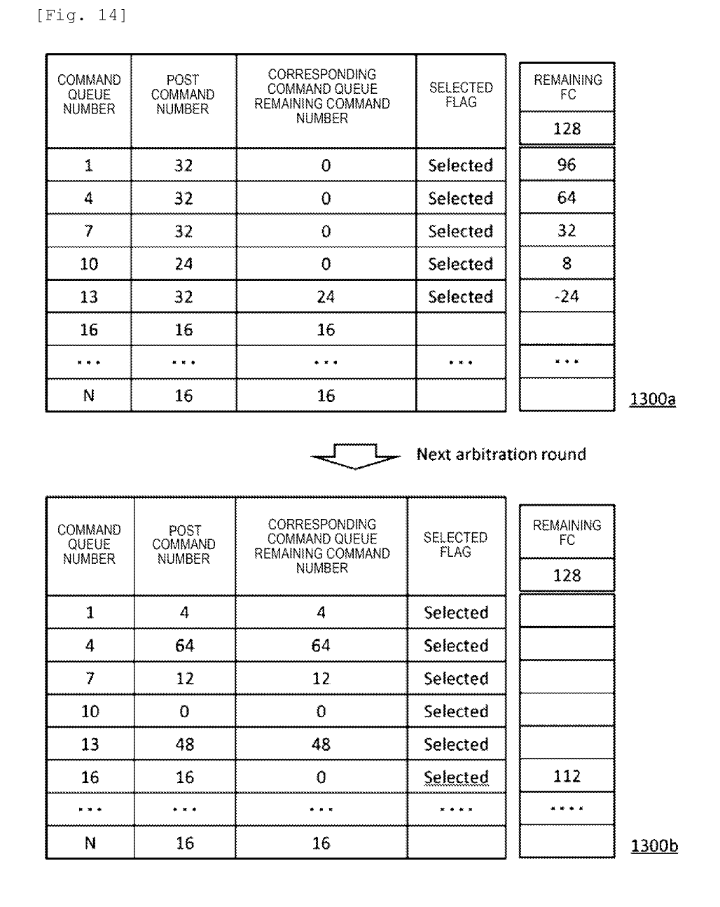

FIG. 14 illustrates a state of change in the processing command number management table 1300 appropriately updated by the arbitration processing described above.

A current state is set as the processing command number management table 1300a illustrated in an upper stage of FIG. 14. In FIG. 14, only entries (rows) relating to command queues with the “high” priority are described, and entries of command queues with other priorities are omitted. In addition, in the following description, it is assumed that a target priority at that time is “high”.

Referring to the processing command number management table 1300a, for example, 32 commands are posted in the command queue whose command queue number is “1”, the number of remaining commands is 0, which is in a selected state. Assuming that the number of remaining fetch commands is 128, since the number of posted commands is 32 and the number of remaining commands is 0, all the commands become processing targets. Thus, the number of remaining fetch commands is 96 obtained by subtracting 32 from 128.

In the same manner, 32 commands are posted in the command queue whose command queue number is “4”, and the number of remaining commands is 0, which is in a selected state. At this time, in the same manner as the command queue whose command queue number is “1”, all the commands posted in the command queue whose command queue number is “4” become a processing target, and thus, the number of remaining fetch commands is 64 obtained by subtracting 32 from 96. As a result of proceeding for the command queues whose command queue numbers are “7” and “10” using the same method, the number of remaining fetch commands is a negative number in the command queue whose command queue number is “13”. The current round ends here. At this time, among the commands posted in the command queue whose command queue number is “13”, eight commands become a processing target.

In the arbitration round in which the next priority is “high”, the processing command number management table 1300b illustrated in a lower stage of FIG. 14 is provided. In the processing command number management table 1300b, the reason that the number of posted commands for some command queues is different from the number of posted commands of the command queue in the processing command number management table 1300a is that the command is posted in the command queue between the end of an arbitration round in which a current priority is “high” and the start of an arbitration round in which next priority is “high”.

Then, in the arbitration round in which the next priority is “high”, the selected flag starts from the command queue of “0”. That is, the command queue whose command queue number is “17” starts first. Then, in the processing for the command queue whose command queue number is “17”, the 16 commands are posted, and thereby, the number of remaining commands becomes zero and the selected flag is set to “1”. In addition, the number of remaining fetch commands becomes 112 obtained by subtracting 16 from 128. By doing so, the number of fetch commands is determined for each command queue.

### (1-3-10) Management Screen

The storage apparatus 110 according to the present embodiment has two operation modes as an operation mode at the time of processing a command from the host computer 105.

A first operation mode is an operation mode (hereinafter, referred to as a high performance mode) in which the storage controller 115 of the storage apparatus 110 generates the number of necessary queue groups configured by a plurality of command queues and completion queues whose priorities are differently set in the storage device 126 by performing the queue generation processing described above with reference to FIG. 7, commands having a higher priority (for example, to be processed as soon as possible) among the IO commands from the host computer 105 are stored in a command queue with a higher priority, and the storage device 126 processes the more commands stored in the command queue with the higher priority in one arbitration round by performing the arbitration processing described above with reference to FIG. 10.

In addition, another operation mode is an operation mode (hereinafter, referred to as a “normal mode”) in which only one queue is provided in the storage device 126, the storage controller 115 sequentially stores the IO commands from the host computer 105 in the queue, and the storage device 126 sequentially processes the commands stored in the queue in the order in which the commands are stored.

In the computer system 100 according to the embodiment, a system administrator can set either the normal mode or the high performance mode as an operation mode when the storage apparatus 110 processes a command from the host computer 105, using a management terminal 140 (FIG. 1) of the storage apparatus 110.

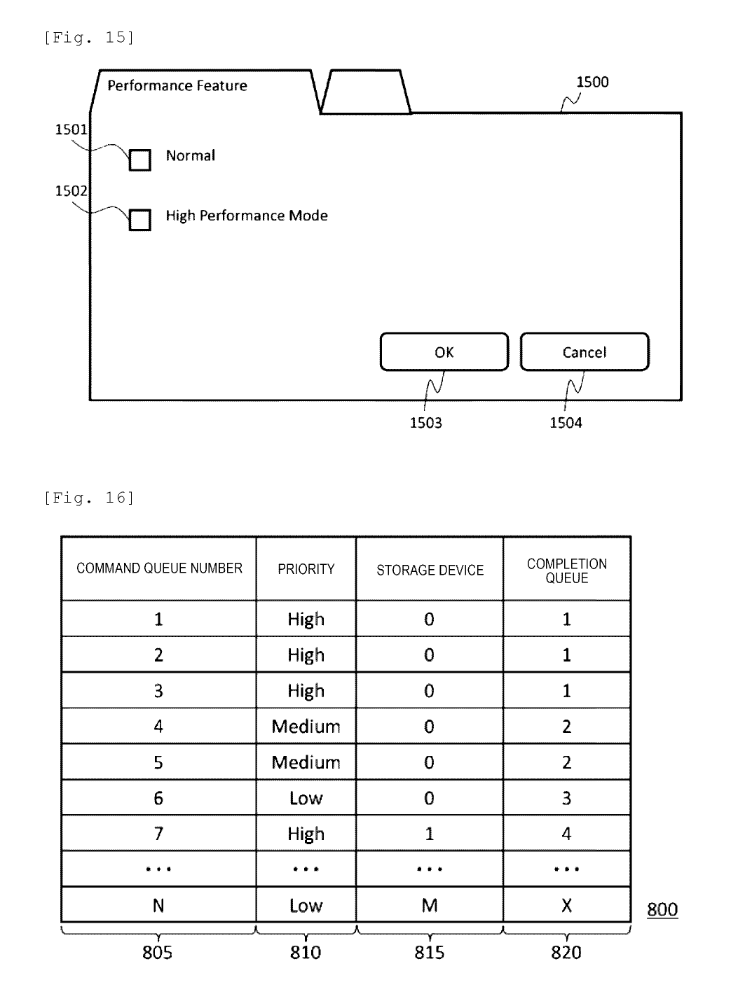

FIG. 15 illustrates a configuration of a management screen 1500 for setting the operation modes. The management screen 1500 can be displayed by performing a predetermined operation on the management terminal 140.

A first check box 1501 provided corresponding to a character string “Normal” indicating the above-described normal mode, a second check box 1502 provided corresponding to a character string “High Performance Mode” indicating a high performance mode, an OK button 1503, and a cancel button 1504 are displayed on the management screen 1500.

The system administrator displays a check mark (not illustrated) in the first check box 1501 by clicking the first check box 1501, and thereafter, can set a normal mode as an operation mode of command processing in the storage apparatus 110 by clicking the OK button 1503, and can set a high performance mode as the operation mode of the command processing in the storage apparatus 110 by clicking the OK button 1503 after the check mark (not illustrated) is displayed in the second check box 1502 by clicking the second check box 1502.

In a case where the operation mode of the command processing of the storage apparatus 110 is set by the system administrator as described above, the operation mode of the command processing of the storage apparatus 110 is set to the operation mode (operation mode set by the system administrator).

By clicking the cancel button 1504, the management screen 1500 can be closed without changing the setting.

### (1-4) Effect of Present Embodiment

In the computer system 100 according to the present embodiment having the above-described configuration, a command requiring faster processing is posted in a command queue with a higher priority, and thereby, the storage apparatus 110 can perform more processing in one arbitration round. Thus, according to the computer system 100, since a command requiring the faster processing is processed more quickly, a processing performance of the storage apparatus 110 can be improved.

In addition, in the present embodiment, the storage controller 115 of the storage apparatus 110 posts a command corresponding to host IO synchronization processing performed in synchronization with an IO request from the host computer 105 in a command queue (command queue with the “high” priority) with the highest priority, posts the constrained host IO asynchronous processing for performing faster processing among multiple pieces of host IO asynchronous processing performed asynchronously with an IO request from the host computer 105 in the command queue (command queue with the “medium” priority) with the second highest priority, and posts unconstrained host IO asynchronous processing not requiring fast processing even in the host IO asynchronous processing in the command queue (command queue with the “low” priority) with the lowest priority, and thus, it is possible to reduce a response time of the storage apparatus 110 as viewed from the host computer 105.

In addition, in the computer system 100, a queue group configured by a command queue whose priority is “high”, a command queue whose priority is “medium”, a command queue whose priority is “low”, and a completion queue is provided so as to correspond to each processor 120, each processor core, and each storage device 126, and thus, each storage device 126 can equally process the commands from each processor 120 and each processor core.

### (2) Second Embodiment

In the first embodiment, an example is described in which commands stored in command queues with higher priority are processed more in one arbitration round, and thereby, commands with higher priority are more preferentially processed.

In contrast to this, the second embodiment is an embodiment of a method of increasing a processing speed by using indirect prioritization (round robin arbitration) according to the number of queues such that more command queues with higher priority are provided, commands respectively posted in each command queue are processed by a certain number of round robin.

In FIG. 1, a reference numeral 2000 denotes a computer system according to the second embodiment. In the computer system 2000, processing contents of queue generation processing performed based on a queue generation program 2004 stored in the memory 122 by the processors 120 of the storage controller 2003 provided in each cluster 2002 of the storage apparatus 2001, and a configuration of the storage device 2005 are different from those in the computer system 100 according to the first embodiment.

Actually, in a case of the present embodiment, when the completion queue is generated in step S710 of the queue generation processing described above with reference to FIG. 7, the processor 120 generates the respective command queues for priority of “high”, “medium”, and “low”. In addition, when command queues with priorities of “high”, “medium”, and “low” are generated in step S715 to step S725, the processor 120 generates more command queues with higher priority.

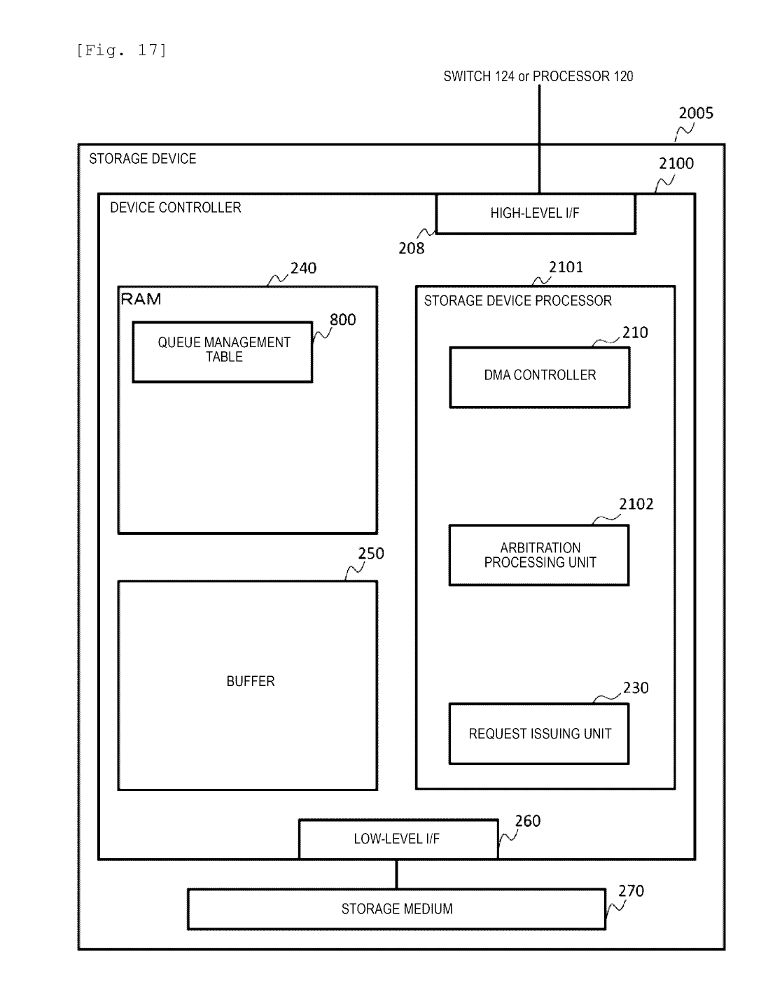

FIG. 16 illustrates a state of a queue management table in which each command queue generated by the queue generation processing is registered. FIG. 16 illustrates an example of a case where three command queues are generated for the priority of “high”, two command queues are generated for the priority of “medium”, and one command queue is generated for the priority of “low”.

In this example, each command queue whose priority is “high” in a certain queue group is associated with a completion queue whose completion queue number is “1” in each queue group, each command queue whose priority is “medium” is associated with a completion queue whose completion queue number is “2” in each queue group, and each command queue whose priority is “low” is associated with a completion queue whose completion queue number is “3” in each queue group. However, the same number of completion queues as the command queue may be generated, and each command queue may be associated with one of the completion queues on a one-to-one basis.

Meanwhile, FIG. 17, in which portions corresponding to those in FIG. 2 are given the same reference numerals or symbols, illustrates a configuration of the storage device 2005 according to the present embodiment. In the storage device 2005 according to the present embodiment, a point in which the command queue selection unit 215 (FIG. 2), the fetch command number determination processing unit 225 (FIG. 2), the maximum command number management table 900 (FIG. 9), and the processing command number management table 1300 (FIG. 13) are omitted, and a point in which processing content of the arbitration processing performed by the arbitration processing unit 2102 provided in the storage device processor 2101 of the device controller 2100 are different from the arbitration processing according to the first embodiment, differ from the storage device 126 according to the first embodiment.

Actually, in the arbitration processing performed by the arbitration processing unit 2102 according to the present embodiment, a target priority is determined in the same manner as in step S1005 to step S1020 of the arbitration processing according to the first embodiment described above with reference to FIG. 10, and thereafter, a predetermined number of commands are respectively selected from all the command queues whose priority is set in a target priority, as a command of a fetch target. In this case, the number (the predetermined number described above) of fetch target commands which are selected from each command queue may be uniform irrespective of the priority, and, for example, the number of commands may be increased for a command queue with a higher priority.

In addition, in a case where there are many command queues corresponding to the target priority for the number of commands that can be fetched, some command queues may be selected from the command queues by, for example, a round robin method, and a predetermined number of commands may be selected from each of the selected command queues as commands of a fetch target.

In the computer system 2000 according to the present embodiment having the above-described configuration, commands requiring faster processing are posted in a command queue with a higher priority thereby being processed more in one arbitration round, in the storage apparatus 2001, in the same manner as in the first embodiment. Accordingly, according to the present computer system 2000, the command requiring faster processing is processed more quickly, and thus, a processing performance of the storage apparatus 2001 can be improved.

In addition, in the computer system 2000, a command of processing target is easily selected and determined in each arbitration round, the command of processing target can be more quickly selected and determined as compared with the arbitration processing according to the first embodiment, and it can be expected that processing performance of the storage apparatus 2001 can be improved more than that.

### (3) Other Embodiments

In the first and second embodiments described above, a case where the computer systems 100 and 200 to which the present invention is applied are configured as illustrated in FIG. 1 and the storage devices 126 and 2005 are configured as illustrated in FIG. 2 or FIG. 17 is described, but the present invention is not constrained to this, and various other configurations can widely be applied as the configurations of the computer systems and storage devices.

In the first and second embodiments described above, a case where priority is set to a command queue, more commands are fetched from command queues with a higher priority, or more command queues with a higher priority are provided is described, but the present invention is not constrained to this, and for example, even by performing indirect prioritization (round robin arbitration) made by adjusting a depth of the command queue, processing speed can be increased as compared with a method of the related art. In this case, by adding a queue entry number field to the queue management table 800 (FIG. 8), the storage devices 126 and 2005 do not require a special mechanism and can be realized by a basic function (a difference with the first embodiment). In addition, the amount of memory consumption is reduced and indirect influence on system performance is reduced (a difference with the second embodiment).

Furthermore, in the first and second embodiments described above, a case where priorities are set as three levels of “high”, “medium” and “low” is described, but the present invention is constrained to this, and the priorities may be set as two levels of “high” and “low”, and furthermore, the priorities may be set as four or more levels.

Furthermore, in the first and second embodiments described above, a case where a system administrator can set a normal mode or a high performance mode as an operation mode of command processing in the storage apparatus 110 by using the management screen 1500 described above with reference to FIG. 15, but the present invention is not constrained to this, and the storage apparatus 110 may be configured to automatically change the operation mode at a predetermined opportunity as necessary.

The present invention is not constrained to the above-described embodiments and includes various modification examples. For example, in the above-described embodiment, the present invention is applied at the time of competition occurring at memory access to a memory board, but is not necessarily constrained to this.

In addition, while not illustrated, various controllers such as a power supply control controller, a battery charge control controller, and an apparatus environment monitoring control controller are provided in the storage controller 115. The present invention can be applied to not only the DMA controller 210 and the processor 120 but also competition between an initiator that issues a command including the above-described controller and a device that receives and processes the command.

Furthermore, the first and second embodiments described above are described in detail so as to explain the present invention in an easy-to-understand manner, and are not necessarily constrained to elements having all the described configurations. In addition, a part of the configuration of one embodiment can be replaced with a configuration of another embodiment, and the configuration of another embodiment can be added to the configuration of the one embodiment. In addition, it is possible to add, remove, and replace other configurations with respect to a part of the configuration of each embodiment.

Furthermore, each configuration, a function, a processing unit, processing means, and the like described above may be realized by hardware, for example, by designing some or all of the elements using an integrated circuit or the like. In addition, each configuration, a function, and the like described above may be realized by software by interpreting and executing a program that the processor realizes each function.

Furthermore, information on a program, a table, a file, and the like which realize each function may be placed in a storage apparatus such as a memory, a hard disk or an SSD, or the storage mediums 126 and 2005 such as an IC card, an SD card, and a DVD.

Furthermore, a control line and an information line represent what is considered to be necessary for description, and do not necessarily represent all control lines and information lines for products. Actually, it may be considered that almost all the configurations are connected to each other.

### REFERENCE SIGNS LIST

100, 2000: computer system, 105: host computer, 110, 2001: storage apparatus, 115, 2003: storage controller, 120: processor, 122: memory, 126, 2005: storage device, 205, 2101: device controller, 215: command queue selection unit, 220, 2102: arbitration processor, 225: fetch command number determination processing unit, 240: RAM, 250: buffer, 270: storage medium, 280, 2101: storage device processor, 140: management terminal, 600, 605: processor core, 610: queue group, 610COM, 612COM, 614COM, 616COM, 610H, 610M, 610L, 612H, 612M, 612L, 614H, 614M, 614L, 616H, 616M, 616L: command queue, 610C, 612C, 614C, 616C: completion queue, 800: queue management table, 1300, 1300a, 1300b: processing command number management table, 1500: management screen

1. A storage apparatus that provides a storage area for reading and writing data from and to a host computer, comprising:
a storage device that provides the storage area; and
a controller that controls reading and writing of data from and to the storage device,
wherein the controller generates a queue group including a plurality of command queues in which different priorities are set, in the controller itself or in the storage device, and posts the command requiring a faster processing among commands for the storage device in the command queue with a higher priority, and
wherein the storage device sequentially and repeatedly performs rounds in which the command is fetched from the command queue with a corresponding priority to be processed, for each priority, and fetches and processes more commands in the round with a higher priority.

2. The storage apparatus according to claim 1,
wherein the controller posts the command to be performed in synchronization with a request from the host computer in the command queue with a high priority, and posts the command requiring faster processing in the command queue with a priority higher than the command which does not require faster processing, for the command which is performed asynchronously with the request from the host computer.

3. The storage apparatus according to claim 2, further comprising:
a plurality of the storage devices,
wherein the controller plurally includes at least one of a processor and a processor core that post the command in the command queue, and
wherein each of the processors and/or the processor cores generates the queue group corresponding to each storage device, and posts the command for the storage device in the corresponding command queue of the queue group.

4. The storage apparatus according to claim 3,
wherein each of the processors and/or the processor cores generates a completion queue in the controller itself or the storage device in the same manner as the command queue,
wherein the storage device posts a completion notification to the completion queue in a case where processing of the command which is fetched from the command queue is completed, and
wherein each of the processors and/or the processor cores fetches the completion notification which is posted in the completion queue.

5. The storage apparatus according to claim 3,
wherein each of the processors and/or the processor cores generates one command queue for each priority in the queue group,
wherein a first command number which is a maximum number of commands capable of being fetched from the one command queue is defined in advance, and a second command number which is a maximum number of commands capable of being fetched in one round is defined for each priority,
wherein the second command number is set to be higher for a higher priority,
wherein the storage device determines the command queue that fetches the command until a total becomes the second command number, from among the command queues with a priority corresponding to the round, in each round, and the number of commands within the first command number to be fetched from the command queue, and
wherein the storage device fetches and processes the command of the number of commands which is determined from the determined command queue.

6. The storage apparatus according to claim 3,
wherein each of the processors and/or the processor cores generates more command queues with higher priority, and
wherein the storage device fetches and processes a predetermined number of the commands from a part or all of the respective command queues, in the round for each priority.

7. An information processing method that is performed in a storage apparatus which provides a storage area for reading and writing data from and to a host computer and which includes a storage device that provides the storage area and a controller that controls reading and writing of data from and to the storage device, the method comprising:
a first step causing the controller to generate a queue group including a plurality of command queues in which different priorities are set, in the controller itself or in the storage device;
a second step causing the controller to post the command requiring a faster processing among commands for the storage device in the command queue with a higher priority; and
a third step causing the storage device to sequentially and repeatedly perform rounds in which the command is fetched from the command queue with a corresponding priority to be processed, for each priority,
wherein, in the third step, the storage device fetches and processes more commands in the round with a higher priority.

8. The information processing method according to claim 7,
wherein, in the second step, the controller posts the command to be performed in synchronization with a request from the host computer in the command queue with a high priority, and posts the command requiring faster processing in the command queue with a priority higher than the command which does not require faster processing, for the command which is performed asynchronously with the request from the host computer.

9. The information processing method according to claim 8,
wherein the storage apparatus includes a plurality of the storage devices,
wherein the controller plurally includes at least one of a processor and a processor core that post the command in the command queue,
wherein, in the first step, each of the processors and/or the processor cores generates the queue group corresponding to each storage device, and
wherein, in the second step, each of the processors and/or the processor cores posts the command for the storage device in the corresponding command queue of the queue group.

10. The information processing method according to claim 9,
wherein, in the first step, each of the processors and/or the processor cores generates a completion queue in the controller itself or the storage device in the same manner as the command queue,
wherein, in the third step, the storage device posts a completion notification to the completion queue in a case where processing of the command which is fetched from the command queue is completed, and
wherein, in the third step, each of the processors and/or the processor cores fetches the completion notification which is posted in the completion queue.

11. The information processing method according to claim 9,
wherein, in the first step, each of the processors and/or the processor cores generates one command queue for each priority in the queue group,
wherein a first command number which is a maximum number of commands capable of being fetched from the one command queue is defined in advance, and a second command number which is a maximum number of commands capable of being fetched in one round is defined for each priority,
wherein the second command number is set to be higher for a higher priority,
wherein, in the third step, the storage device determines the command queue that fetches the command until a total becomes the second command number, from among the command queues with a priority corresponding to the round, in each round, and the number of commands within the first command number to be fetched from the command queue, and
wherein the storage device fetches and processes the command of the number of commands which is determined from the determined command queue.

12. The information processing method according to claim 9,
wherein, in the first step, each of the processors and/or the processor cores generates more command queues with higher priority, and
wherein, in the third step, the storage device fetches and processes a predetermined number of the commands from a part or all of the respective command queues, in the round for each priority.
